(19) United States
(12) Patent Application Publication
(10) Pub. No.: US 2016/0069725 A1
(43) Pub. Date: Mar. 10, 2016

(54) Integrated Measuring Cup and Cutting Board Edges

(71) Applicants: Mark Prommel, Brooklyn, NY (US); Marco Perry, Brooklyn, NY (US); Matthew Kalish, Saugerties, NY (US); Pil Ho Chung, Jersey City, NJ (US); Kevin O'Leary, Brooklyn, NY (US)

(72) Inventors: Mark Prommel, Brooklyn, NY (US); Marco Perry, Brooklyn, NY (US); Matthew Kalish, Saugerties, NY (US); Pil Ho Chung, Jersey City, NJ (US); Kevin O'Leary, Brooklyn, NY (US)

(21) Appl. No.: 14/482,490

(22) Filed: Sep. 10, 2014

(51) Int. Cl. G01F 19/00

(52) U.S. Cl. CPC G01F 19/00

(57) ABSTRACT

A measuring cup with a base, opposed side walls, a rear wall and a higher in elevation front wall. Quantity markings are provided. The front wall has an outwardly extending lip. With the lip on a table top, the front wall slants downwardly from the lip to thereby maintain foodstuff therein. A cover seals the measuring cup. It has a flat section about the dimensions of the base so that a second measuring cup can be stacked on the cover of the first. A cutting board is provided with a bevel or undercut edge for mating engagement with the lip of the measuring cup to allow easy transfer of cut foodstuff from the cutting board and into the measuring cup.

### BACKGROUND OF THE INVENTION

The present invention relates to a measuring cup for use in the kitchen which is integrated for ease of use with a cutting board so that dicing, cutting, slicing of fruits, vegetables, and other food stuffs is accomplished on the cutting board, in a conventional manner, and, then, by the edge of the cutting board being angled and mating with the top edge of the front side of the measuring cup, the passage of cut foodstuff from cutting board to measuring cup is seamless, clean, and easy. And, by having the angle of the lip of the front side of the cup an an angle, food put into the cup while on its side will be maintained there as the lip of the cup is the high point of the “bottom” which is really the front side of the cup. Thus, a chef, cook, food preparer can cut foodstuff on the cutting board and quickly transfer the same to a measuring cup, without mess, to determine the quantity of foodstuff available for a recipe. A sealable lid is also provided which allows for preservation of food contained within the measuring cup and also allows other measuring cups to be easily stacked, one upon the other.

### DESCRIPTION OF THE PRIOR ART

Cutting boards are common kitchen items, useful for cutting, slicing, dividing, paring foodstuffs, e.g., vegetables, garlic cloves, fruits, meats, poultry, etc. Often, the quantity of the cut up foodstuff is required, in cups, for example, for addition to other foodstuffs, to make a complete meal or meal portion. Recipes often dictate specific quantities of sliced, diced, or cut food to be added to other food components to make an appetizer, a salad, entree, etc.—½ cup of chopped onion; 1 cup of sliced green peppers; 1½ cups of sliced strawberries; 2 cups of cubed steak (for a salad); 1 cup of chopped scallions, etc. Thus, the acts in a kitchen of slicing, chopping, dicing, all conventionally and often done on a cutting board, is the first of a two step process to produce the desired quantity of the food, which, just as conventionally, then requires the transfer of the food, just cut, sliced, diced (hereinafter collectively referred to as “cutting”) from cutting board into a measuring cup. That transfer is often done by raising the cutting board over the measuring cup and using a spatula, a side of the knife blade, even one's hand, to push the cut food into the measuring cup, located with its base on the counter. That seems messy and can lead to transferring of the cut food onto the counter, not into the measuring cup.

Measuring cups are also very common kitchen “gadgets,” serve as an aide to cooking, even considered a cooking utensil. Measuring cups generally come in a variety of sizes to accommodate various measures, e.g., a ½ cup; 1 cup; 1½ cup; 2 cup; even a 4 cup volume of measuring cup. These measuring cups have been provided to consumers for years in stainless steel, rubber, plastic, glass, etc. They have side wall markings, interior and/or exterior, to enable the measurer (the cook or chef of the moment) to determine the quantity of food within the cup's interior cavity. These are quite conventional. Transferring cut food from cutting board to measuring cup has been messy, however.

Measuring cups have also been provided in the past with lids, tops, closures so that the same can be maintained, with food therein, for later use, storage in a refrigerator, cupboard, on a shelf, etc. These lids or closures can be rubber, glass, plastic, even plastic film and cover the top opening of the measuring cup until desirably removed for access to the food within the cup. The lids have been provided in various types but generally provide a relatively air-tight seal. The sealing lids are provided with a gripping slot which accepts the upper edge of the measuring cup and holds the lid to the measuring cup until desirably removed, done by peeling the same from the top of the cup.

If a measuring cup of the prior art were laid on its side to ease the transfer of food from cutting board to the cup, it would not be an easy nor simple transfer but, rather, would likely be messy, complicated by the food draining out of the cup and onto the table top, as the side wall on the table top is parallel to the table top.

Until the present invention, to Applicant's knowledge, there has not been provided a measuring cup which is provided with an angled top edge on one side which mates with the perimeter edge of a cutting board such that the two articles can be easily used to transfer the cut food from the cutting board quickly, easily, seamlessly and without mess, to the measuring cup. The present invention provides these functional characteristics.

Prior to the present invention, there has not been a measuring cup which allows for the same to lay on its side and maintain all food from sliding out of the same. Prior to the present invention, there hasn't been a measuring cup with a sealing lid which allows for the easy stacking of measuring cups, each having a lid as a closure. The present invention provides these features.

### SUMMARY OF THE INVENTION

The present invention relates to a measuring cup which integrates with cutting board. Preferably, the cutting board is provided with at least one side (of a generally rectangular shape with curved corners), preferably on all sides, with an undercut edge or bevel. Thus the slightly smaller in surface are of the planar surfaces of the cutting board rests upon the table top while the slightly larger planar surface, the top of the cutting board, faces upward, with food to be cut thereupon.

A preferable transparent measuring cup preferably formed of plastic, with or without a handle, comprises a top edge of a front side which is elevationally higher than the opposed or back side. The front and back sides are connected by side walls. Preferably, the measuring cup is provided in a specific convenient size, with other cups of the same series provided, in different yet incrementally distinct sizes. The top edge or the high side of the front surface of the measuring cup is provided with an outwardly extending flange, forming a small incline or ramp into and onto the front side, when the front side is laid down on a table top. When held adjacent to the cutting board, with its undercut edge, the two components mate. The measuring cup slides beneath the undercut edge or bevel of the cutting board. The angled flange of the measuring cup will mate with the bevel or undercut edge of the cutting board. And, the edge of the flange will hold the front side of the measuring cup at an angle to the table top. The thickness of the cutting board and the angles of the cutting board and the flange cooperate so that the measuring cup is adjacent the cutting board and cut food can be easily into the measuring cup, without the food backsliding onto the cutting board. Basically, when the cutting board and the measuring cup are slid together, a co-planar surface is provided, the inside front wall of the measuring cup and the top of the cutting board. Thus, food stuff cut on the cutting board can easily, seamlessly, without mess and quickly be slid from the surface of the cutting board and into the measuring cup. Then, the measuring cup can be stood upon its base and the quantity of foodstuff therein (just cut) can be easily and accurately measured by the side-wall markings.

It is also an aspect of the present invention to provide the measuring cups disclosed herein with sealing lids for use with storage of foodstuff within the measuring cups. The sealing lids are conventional in attachment to the top edges of the measuring cups. However, of course, some extending flange must be provided to the lid, to cover and grip the flange of the measuring cup. In addition, the lid is provided with a level, flat, planar surface corresponding to the dimensions of the base of the measuring cup so that the base of one measuring cup can fit on and be stably secured on the planar surface of the lid.

### BRIEF DESCRIPTION OF THE DRAWINGS

FIG. 1 is a rear perspective view of the measuring cup and lid according to the present invention;

FIG. 2 is a front and side perspective view of an open measuring cup, on its side, showing the retention of foodstuff therein, even when the measuring cup is laid down on its side; and

FIG. 3 is a side elevational view of a measuring according to the present invention as held adjacent to a cutting board, with its front side just above the table top, also made consistent with the present invention.

### DETAILED DESCRIPTION OF THE DRAWINGS AND THE PREFERRED EMBODIMENT

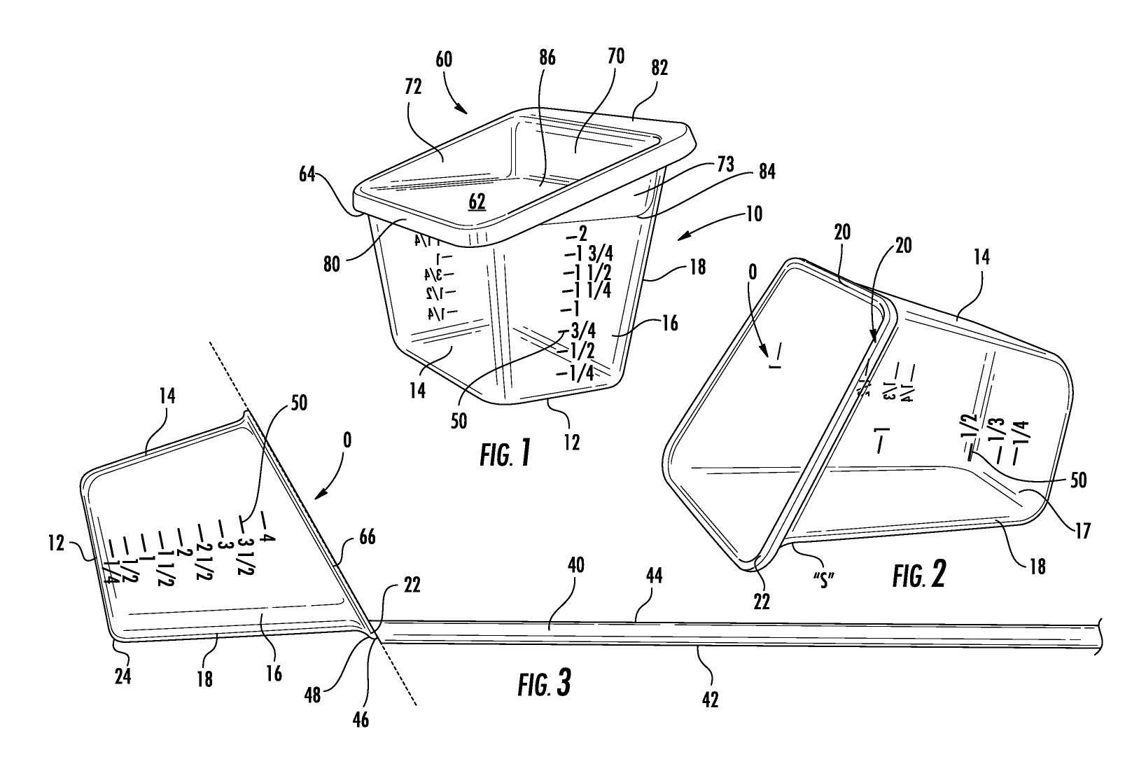

Description will now be given of the invention with reference to the attached FIGS. 1-5. It should be understood that these figures are exemplary in nature and in no way serve to limit the scope of the invention as the invention will be defined by the claims, as interpreted by the Courts in an issued U.S. Patent.

A measuring cup 10 is provided. It comprises a base 12, a relatively short, back wall 14, a pair of opposed side walls 16, 17 and a tall (in relative height) front wall 18. Preferably, the measuring cup is made of shatterproof glass or a sturdy and clear plastic. Quantity or volume markings are located, by printing onto the front, rear, and/or side walls, as is quite conventional in measuring cups of this general type. Some markings can be in cups, others in metrics. Here, for example, on the side wall 16 are quantity markings 50 indicative of ¼ cup, ½ cup, ¾ cup, 1 cup and similar markings up to 2 cups. The quantity markings 50 or measurement indicators can be provided on both or either the inside or outside of the walls but reflects a volume of material, say, for example, diced onions, poured sugar, cut scallions, measured from the base 12 of the measuring cup vertically up the side, rear and front walls, when the measuring cup is placed on a table top with its base thereon.

The top edge 20 of the measuring cup 10 is a small width-wise enlargement of the thickness of the walls with the exception of the flange or support lip 22 for the front wall 18. As can be seen in FIGS. 2 and 3, the support lip 22 extends forwardly and hangs over and beyond the front wall 18. Indeed, as can be appreciated from FIG. 3, the support lip 22 is a forward extension of the line defined by the top edge 20 of the side walls 16 and 17. Thus, since the rear wall 14 is shorter in height than the front wall 18, the support lip 22 defines an angle with respect to bottom 12, especially appreciated when the measuring cup is laid on its front wall, on a table top. In this manner, see FIG. 2, the front wall is elevated, slightly above, the table top with the elevation tapering to the point where the intersection 24 (see FIG. 3) of the front wall with the forward, bottom lies directly upon the table top. Thus a space “S” is provided between the top of the table top and the front wall 18, when the support lip 22 is laid upon the table top and the intersection 24 of the front wall 18 and bottom 12 is also on the table top. The angle provided to the front wall 18 when the support lip is on a table top dictates that the high point of the front wall 18, when in the “laid on its side” position, shown in FIGS. 2 and 3, is near the support lip and the low point of the front wall is near the table top, as the same is lain thereon. Thus, cut food pushed into the opening O, with the front wall in the lain down position (FIGS. 2 and 3) will tend to stay within the cavity defined by the bottom, side walls, front wall and rear wall and not easily flow out, unintentionally. This is important when one understands how the measuring cup 10 interacts with the cutting board 40 (See FIG. 3).

Cutting board 40 is a wood, plastic or otherwise hard surface for dicing, chopping, cutting of food. It has a bottom surface 42 and a top cutting surface 44. It can be any shape, although rectangular with curved corners is likely preferred. The thickness of the cutting board, for the measuring cup and cutting board to integrate together to maximum effectiveness, is about the dimensional protrusion of the support lip 22 over the front surface of front wall 18. When the front wall 18 is lain on a table top, as shown in FIGS. 2 and 3) the insider surface of the front wall is basically coplanar with the top surface 44 of the cutting board. Thus, cut food on the cutting board can easily be pushed or swiped into the opening O of the measuring cup and held in the cavity of the measuring cup. Then, when desired, the measuring cup can be moved to its measuring position where the bottom or base is on the table top (See FIG. 1) and the quantity of food therein will likely redistribute by gravity and the approximate quantity of the same within the cavity can be read by the quantity markings 50 or measurement indications.

In an alternative embodiment of the present invention, to further ensure the ease and absence of mess for transferring cut food from cutting board into cavity of the measuring cup, one or more edges or surface areas 46 of the cutting board are provided with an undercut 48. At the undercut 48, the top surface of the cutting board 44 overlies the table top and not the bottom surface while the bottom surface of the cutting board 42 is directly on the table top. Stated differently, the angle of the undercut to the top surface of the cutting board is basically the same as the angle of the support lip so that the undercut of the cutting board and the support lip, mate and there is little space between the support lip and the edge 46 of the cutting board. Thus, food scraped from the top surface of the cutting board will easily and smoothly be pushed into the cavity of the measuring cup, without mess. The angle of the undercut, taken from the side, is basically the same angle defined by the support lip, viewed from the same side of the measuring cup, as seen in FIG. 3. When the measuring cup is pushed up against the edge 46 provided with the undercut, the top of the cutting board is coplanar with the inside surface of the front wall of the measuring cup.

AS can be seen in FIG. 1, a lid 60 can be sealingly provided to the measuring cup. It can be removed as desired or placed on the measuring cup to seal the same for placement of cup with contents into a refrigerator, a cupboard, etc. And, as can be appreciated, the lid 60 is provided with a flat and level surface 62 of about the same dimension (but slightly larger) as the bottom 12 of the measuring cup, so that a second measuring cup 10 can be placed on the level surface 62 and thus multiple measuring cups can be stacked with a bottom on the level surface 62 of the lid 60 of the measuring cup just beneath. Clearly, multiple measuring cups can be stacked with bottom supported on the level surfaces 62 of the lids 60. Each lid 60 is provided with a sealing channel 64 which is formed of about the thickness of the walls and frictionally held thereon when press fit. Yet, of course, the lids 60 can be removed as desired by peeling the channels 64 from the top edges 66 of the walls. Three sides of the lid 60 are formed of the continuous channel 64 and the front of the lid (overlying the front wall 18 of the measuring cup) extends over the support lip and grips it, for sealing. The forward wall 70 of the lid is vertical and runs a short distance down the front wall and is parallel thereto. Side walls 72 and 73, run along the extend down from the forward wall 70 of the lid, too. Thus, it should be easily appreciated that the lid provides a level surface 62 which is parallel to the bottom 12 of the measuring cup, when lid is sealed to cup, and thus the level surface is a planar support for the bottom of another measuring cup. Stated differently, the level surface 62 is recessed so that it is parallel to the bottom 12, so that the rear of the lid 80 is just above the top of the rear wall 14 with the front 82 of the lid 60 just above the top edge or support lip of the flange of the front wall 18. The intersection 86 of the forward wall 70 and the level surface 62 is located at the front of the lid and adjacent to the front wall 18.

In use, a cook food preparer can use a cutting board 40 in conventional manner, dicing, slicing or cutting food. Then, when a quantity is desirably measured, the preparer can locate a measuring cup adjacent to the cutting board, with front wall on the table top and support lip adjacent and abutting the undercut of the cutting board. Then, the preparer can push the cut food into the cavity and turn the measuring cup on its bottom. Quantity of food can be seen on the side wall markings. If desired, a lid can be snapped onto the upper edges of the measuring cup by having the channel of the lip frictionally engaged by the upper edge of the walls of the measuring cup. The cup, with contents can be stored, as desired. When further contents desired, the lid can be peeled off. As mentioned, the level support 62 of the lid of one measuring cup serves as the support surface for the bottom 12 of another measuring cup.

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

What I claim is:

1. A measuring cup comprising a bottom, a rear wall and front wall, and a pair of opposed side walls connecting said rear wall to said front wall, said measuring cup having quantity marking means on at least one of said front wall, side walls or rear wall; said front wall being higher in elevational dimension than said rear wall when said bottom is on a table top; and the top edge of said front wall having a support lip projecting and extending outwardly beyond said front wall and said support lip being angled with respect to said front wall.

2. A measuring cup as claimed in claim 1 wherein said front wall, rear wall and side walls each define a top edge and further comprising a lid for substantially air-tightness of said measuring cup, said cover gripping to said top edges.

3. A measuring cup as claimed in claim 1 wherein at least one of said walls provided with said quantity marking means is transparent.

4. A measuring cup as claimed in claim 1 wherein said angle of said support lip with respect to said front wall is obtuse.

5. A measuring cup as claimed in claim 1 wherein when said front wall is placed on a table top surface, said front wall is angled with respect to said table top surface

6. A measuring cup as claimed in claim 1 wherein said front wall, when adjacent a table top surface is tilted downwardly away from said support lip to said bottom.

7. A measuring cup as claimed in claim 2 wherein said lid is provided with a sealing channel for interaction with said top edges of said rear wall, said front wall and said side walls and said lid is provided with a planar and level contact and support surface, substantially aligned with and parallel to said bottom.

8. A measuring cup as claimed in claim 7 wherein said contact and support surface is about the same dimension of said bottom.

9. A measuring cup as claimed in claim 8 wherein said lid is provided with side walls, a forward wall and a rear wall which mate with said top edges of said side walls, said front wall and said rear wall of said measuring cup.

10. A kitchen aide as claimed in claim 1 further comprising a cutting board having a side surface segment which is angled with an undercut which mates with said support lip of said measuring cup.
